(19) United States
(12) Patent Application Publication
(10) Pub. No.: US 2016/0169515 A1
(43) Pub. Date: Jun. 16, 2016

(54) EDGE COOLING FOR COMBUSTOR PANELS

(71) Applicant: UNITED TECHNOLOGIES CORPORATION, Hartford, CT (US)

(72) Inventors: John S. Tu, West Hartford, CT (US); James P. Bangerter, East Hartford, CT (US); Robert Sze, Mississauga (CA); James B. Hoke, Tolland, CT (US); Monica Pacheco-Tougas, Waltham, MA (US)

(21) Appl. No.: 14/908,751

(22) PCT Filed: Aug. 5, 2014
(86) PCT No.: PCT/US14/49686

§ 371 Date: Jan. 29, 2016

Related U.S. Application Data
(60) Provisional application No. 61/875,850, filed on Sep. 10, 2013.

(51) Int. Cl. F23R 3/06; F23R 3/00; F02C 7/18

(52) U.S. Cl. CPC F23R 3/06; F02C 7/18; F23R 3/002

(57) ABSTRACT

A combustor panel an increased cooling holes provided at at least one of a pair of circumferential edges, a leading edge, a trailing edge or a hole circumference. The increase may be defined as a reduction in spacing or an increase in density. In another feature, holes at the circumferential edges may extend outwardly to an outlet in alignment with rails.

### CROSS-REFERENCE TO RELATED APPLICATION

This application claims priority to U.S. Provisional Application No. 61/875,850, filed Sep. 10, 2013.

### BACKGROUND

This application relates to improved cooling techniques for combustor panels for use in a gas turbine engine.

Gas turbine engines are known and, typically, include a compressor which compresses air and delivers it into a combustor. The air is mixed with fuel and ignited. Products of this combustion pass downstream over turbine rotors driving them to rotate.

The combustor sees very high temperatures due to the combustion. As such, efforts are made to assist the combustor in surviving these high temperatures.

To assist in protecting combustors, heat resistant panels are placed along an outer shell. The heat resistant panels are provided with cooling air openings. In particular, the outer shell may be spaced from an inner panel which faces the products of combustion. Holes extend through the outer shell and impinge on an outer face of the inner panel and then move through other holes in the inner panel to provide film cooling to an inner face of the inner panel.

In the prior art, the holes are generally spaced uniformly about the inner panel.

### SUMMARY

In a featured embodiment, a combustor for use in a gas turbine engine has a panel with first cooling holes extending through the panel. The first cooling holes communicate with an inner face of the panel to deliver cooling air to the inner face of the panel, and an outer shell attached to the panel. The outer shell has second cooling holes extending to deliver air to a chamber between the outer shell and the panel, and then into the first cooling holes. There is a nominal average spacing of at least one of the second cooling holes and the first cooling holes per an entire surface area of the outer shell or the panel, respectively. There is a reduced spacing area of the at least one of the second cooling holes and the first cooling holes adjacent to at least one edge on the panel. At least one of the second cooling holes and the first cooling holes in the reduced spacing area is spaced by a distance less than the nominal average spacing.

In another embodiment according to the previous embodiment, the edge is an outer surface of a boss around a circumference of one of the dilution or an ignitor hole.

In another embodiment according to any of the previous embodiments, a rail is provided about an outer face of the panel, and the edge is measured from a wall of the rail facing into the panel.

In another embodiment according to any of the previous embodiments, the edge is a leading edge of the panel.

In another embodiment according to any of the previous embodiments, the edge is a trailing edge of the panel.

In another embodiment according to any of the previous embodiments, the edge is circumferential edges of the panel.

In another embodiment according to any of the previous embodiments, at least at the circumferential edges, the first cooling holes extend from the outer face of the panel to an outlet at the inner face at a location aligned with the rail at the circumferential edges.

In another embodiment according to any of the previous embodiments, the first cooling holes extend in opposed angular directions that are non-perpendicular and non-parallel to the outer face, such that the outlets are spaced closer to each of the circumferential edges than are inlets to the first cooling holes.

In another embodiment according to any of the previous embodiments, at least one of the second cooling holes and the first cooling holes is the second cooling holes.

In another embodiment according to any of the previous embodiments, at least one of the second cooling holes and the first cooling holes is both the second cooling holes and the first cooling holes.

In another embodiment according to any of the previous embodiments, the reduced spacing area also has a greater density of cooling hole area than a nominal average density of cooling hole area.

In another embodiment according to any of the previous embodiments, a spacing between adjacent ones of at least one of the second impingement cooling holes and the first cooling holes in the reduced spacing area is equal to or less than ten (10) average diameter of the first cooling holes.

In another embodiment according to any of the previous embodiments, the term adjacent is defined by being spaced by a distance from at least one edge equal to or less than ten (10) average diameter of the at least one of the second cooling holes and the first cooling holes.

In another embodiment according to any of the previous embodiments, the first cooling holes are effusion cooling hole and the second cooling holes are impingement cooling holes.

In another embodiment according to any of the previous embodiments, the reduced spacing area is between the first cooling holes and at both circumferential edges, one of a leading and a trailing edge of the panel, and at a circumference of a dilution or ignitor hole.

In another featured embodiment, a combustor section for a gas turbine engine has a panel with effusion cooling holes extending through the panel, and communicating with an inner face of the panel to deliver cooling air to the inner face of the panel. An outer shell is attached to the panel, and has impingement cooling holes extending to deliver air to a chamber between the outer shell and the panel, and then into the effusion cooling holes. There is a nominal average density of effusion cooling hole area per surface area of the panel, and an increased density area of cooling holes adjacent to at least one edge on the panel. The increased density area has a density greater of cooling hole area than the nominal average density.

In another embodiment according to the previous embodiment, the impingement cooling hole also has an increased density area adjacent to the at least one edge.

In another embodiment according to any of the previous embodiments, an outer face of the panel has a rail, at least at the circumferential edges, and the effusion cooling holes extends from the outer face of the panel to an outlet at the inner face at a location aligned with the rail at the circumferential edges.

In another embodiment according to any of the previous embodiments, the term adjacent is defined by being spaced by a distance from at least one edge equal to or less than ten (10) average diameter of the effusion holes.

In another embodiment according to any of the previous embodiments, the increased density area is found at both circumferential edges, one of a leading and a trailing edge of the panel, and at a circumference of a dilution or ignitor hole.

In another embodiment according to any of the previous embodiments, a combustor for use in a gas turbine engine has a panel with a pair of circumferential edges, a leading edge and a trailing edge, with first cooling holes extending through the panel and communicating with an inner space of the panel to deliver cooling air to the inner face of the panel. An outer shell is attached to the panel. The panel has an outer face with a rail extending to contact the outer shell. The rail is formed at least at the circumferential edges of the panel. The outer shell has second cooling holes extending to deliver air to a chamber between the outer shell and the panel, and then into the first holes. The first cooling holes include an inlet on the outer face, and extend to outlets at the inner face, with the outlets of some of the first cooling holes being spaced closer to the circumferential edges of the panel than the inlets such that outlets of some of the first cooling holes will be aligned with the rails at each of the circumferential edges.

These and other features may be best understood from the following drawings and specification.

### BRIEF DESCRIPTION OF THE DRAWINGS

FIG. 1 shows a gas turbine engine.

FIG. 2 shows a combustor.

FIG. 3 shows a panel within a combustor.

FIG. 4A shows a first feature.

FIG. 4B shows a reverse side of the FIG. 4A panel.

FIG. 4C shows a portion of an outer shell.

FIG. 4D shows another feature.

FIG. 4E shows another feature.

FIG. 4F shows a detail of the features.

### DETAILED DESCRIPTION

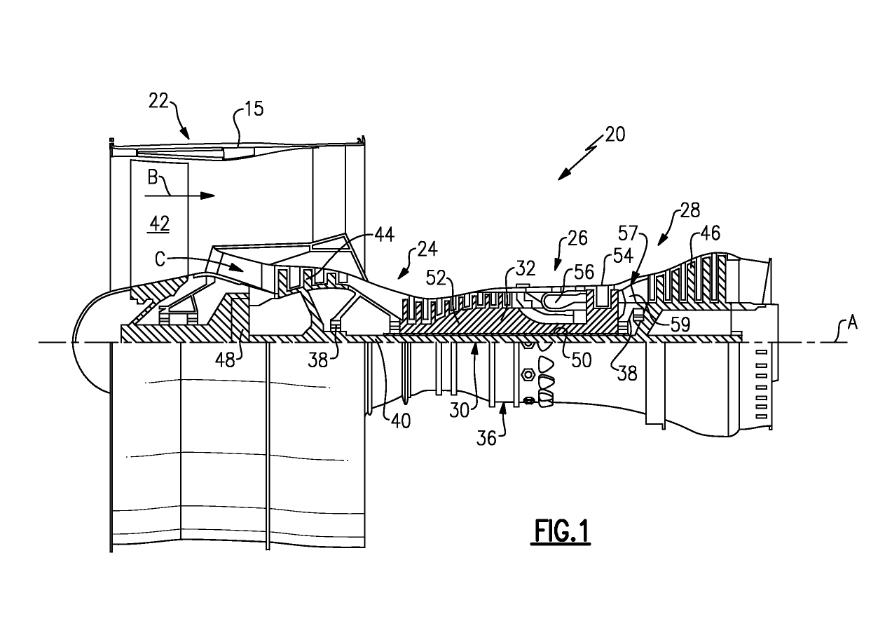

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

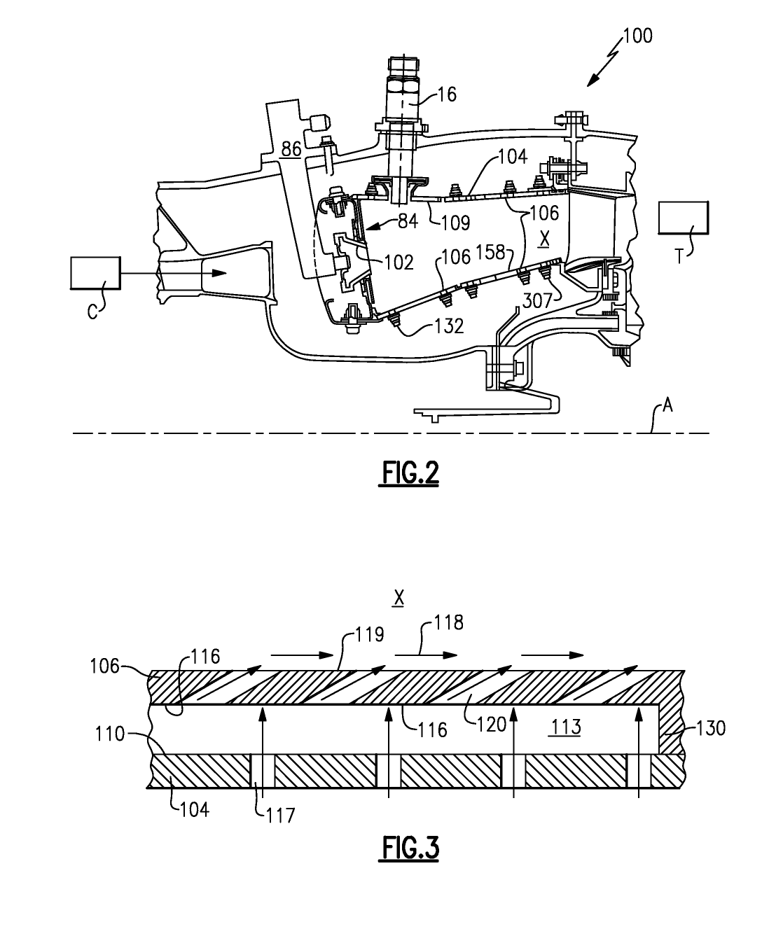

FIG. 2 shows a combustor 100 incorporating a swirler 102 which mixes air and fuel from an injector 86, such that they can be ignited by igniter 16. An outer shell 104 is secured to inner panels 106 by studs 132. The outer shell 104 surrounds a combustor chamber X. Dilution holes 158 may extend through the panel 106 and outer shell 104 and provide cooling air to an inner surface. Studs 132 secure the panels 106 to the outer shell 104.

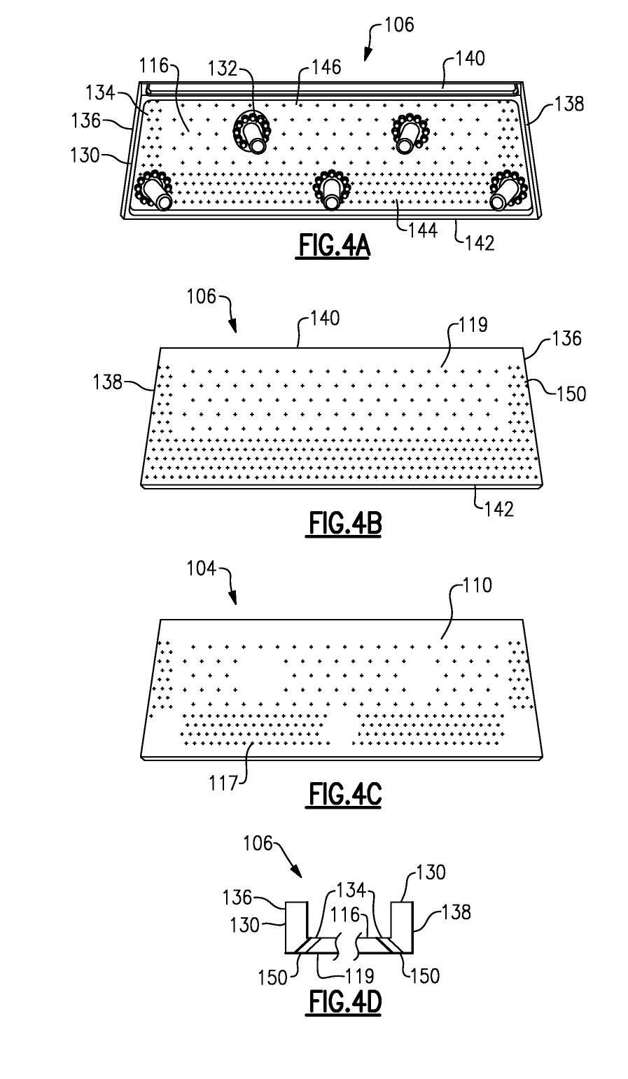

FIG. 3 shows the outer shell 104 having an inner surface 110 spaced from an outer face or surface 116 of the panel 106. The term “outer” should be interpreted as facing away from the chamber X, while “inner” means facing the chamber X.

A plurality of impingement cooling holes 117 provide impingement air flow into a chamber 113 defined between the surfaces 110 and 116.

A plurality of effusion cooling holes 120 extend at an angle which is non-perpendicular, and non-parallel, to the surface 116 and provide film cooling to an inner face 119 of the panel 106. The film cooling air 118 passing along face 119 assists the panel 106 in surviving the hot temperatures.

Applicant has recognized that the cooling load along the faces 110 and 119 is not uniform across the entirety of the outer shell 104 and inner panel 106.

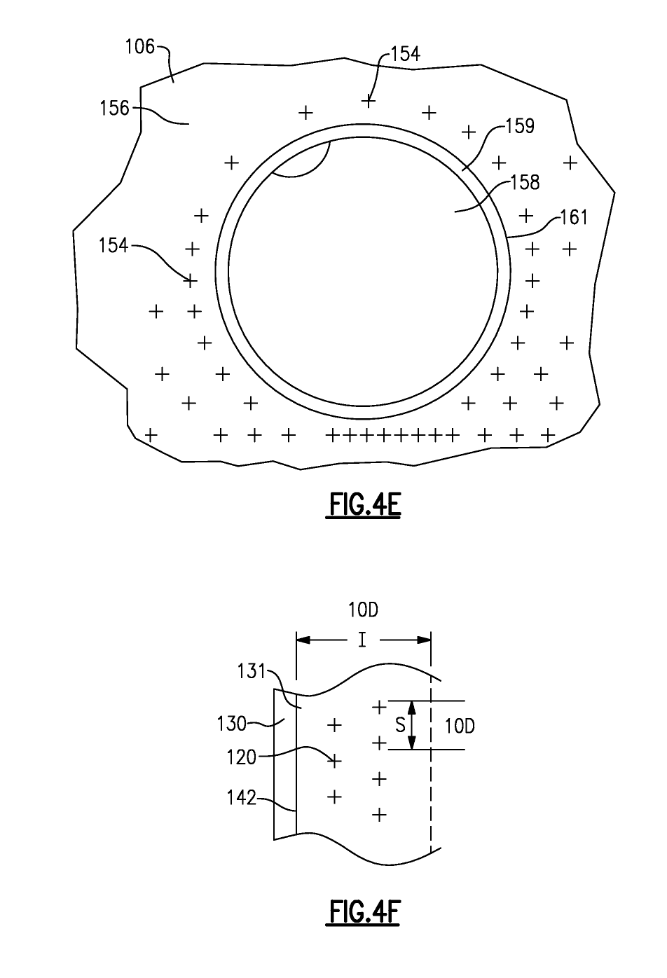

As shown in FIG. 4A, the panel 106 has circumferential side edges 136 and 138. As shown, there is a greater number of cooling holes 144 at leading edge 142 than there are holes 146 adjacent the trailing edge 140. Similarly, there are a greater number of holes 134 adjacent the circumferential edges 136 and 138 than are nominally found centrally between the edges. Applicant has found that the cooling load along the edges is greater than the cooling load adjacent the center portion of the panel 106 or at the downstream edge 140. The cooling holes shown in FIG. 4A correspond to an upstream end of holes 120 of FIG. 3.

The leading edge 142 would preferably have the greater density on an aft panel. There are also forward panels, where the greater cooling load may be at the trailing edge. For purposes of this application, the greater density could be at either, depending on the ultimate use of the panel. Thus, in an alternative to FIG. 4A, the edge 142 may be a trailing edge. Of course, there may be structural or shape differences between the panels used at those two locations.

As will be explained below, the “edge” will be measured from a wall of the rail facing a central portion of the panel 106.

As shown in FIG. 4A, there is also a rail 130 that surrounds the circumference of the panel 106. As can be appreciated from FIG. 3, the rail 130 contacts the surface 110 of the outer shell 104.

As shown in FIG. 4B, there are outlets 150 associated with holes 134 adjacent the edges 136 and 138, and which exit at a location underneath the location of the rail 130. That is, the outlets 150 are aligned with the location of the rails 130 at the edges of the panel 106.

FIG. 4C shows a portion of the outer shell 104. The inner face 110 would have a plurality of impingement cooling holes 117, and would have the higher density and closer spacing which tracks that of the panel 106. That is, the higher density and closer spacing would be adjacent at least one edge.

FIG. 4D shows details of the holes 134. As shown, an inlet to the holes 134 on the outer face 116 extends at an angle that is non-perpendicular and non-parallel to the face 116, and each extend generally outwardly toward their respective edges 136 and 138 such that the outlet 150 is aligned with the location of the rails 130. The holes 134 extend at the edge 136 and 138, at each of the circumferential directions such that outlets 150 are is spaced closer to each of the circumferential edges than is an inlet to the effusion cooling holes 134.

FIG. 4E shows a dilution hole, such as holes 158 as shown in FIG. 2. Applicant has also recognized that the edges of dilution holes 158 carry a higher cooling load than do more remote portions of the central area of the panel 106. Thus, there is a greater number of effusion cooling holes 154 adjacent the edge of the bore forming the hole 158 than at more spaced locations, say location 156. While this feature is illustrated about dilution hole 158, an ignitor, such as ignitor 16 may be surrounded by a hole. Thus, in another embodiment, hole 134 surrounds an ignitor 16. Such holes are generally much larger than effusion cooling holes 120.

A boss 159 is shown surrounding the circumference of the hole 158. A peripheral surface 161 becomes the measuring point for the “edge” as defined within this application.

In general, this application discloses a greater volume or density of holes adjacent at least one of the edges of the panel, with the edges being either the leading or trailing edge, one of the side edges or the circumference of a hole, such as a hole for dilution cooling or surrounding an ignitor.

The greater density is defined with regard to the density of the other effusion cooling holes at locations spaced away from the edge. For purposes of this application, the holes 120 have an average diameter and the term “adjacent” the edge is less than or equal to ten (10) average diameters from the edge.

Stated another way, an average density of an area of the holes 120 across the entire surface area of a panel 106 may be defined and there is greater density area adjacent at least one of edges 136, 138 and 142 or along the circumference of the holes 158. One could say that there is a nominal average density of a effusion cooling hole area for the entire surface area of the panel, and there is an increased or greater density area of cooling hole area adjacent to at least one of the edges. In embodiments, the greater density may be at more than one edge, and may be at all of the edges.

In embodiments, a ratio of the cooling hole area per unit of area at said greater density area to the nominal average density of cooling hole area is between 1.25 and 2.0.

FIG. 4F shows the edge 142 and the density of holes 120 within a distance I equal to 10D (the D representing an average diameter of the dilution holes) from the edge 142. As shown, the rail 130 has the wall 131 facing a central portion of the panel. It is this wall 131 which defines the “edge” for purposes of the measurement of this application. In addition, there is a closer or reduced spacing S between the cooling holes 120 in the greater density area. Thus, the greater density area is also a reduced spacing area. The spacing S between adjacent cooling holes is preferably less than 10D. It should be understood that the holes 120 need not be cylindrical, and thus the average diameter D should be interpreted as being the average hydraulic diameter.

The wall 131 and the peripheral surface 161 would also be used to define the location of the “edge” for the reduced spacing and higher density areas of the impingement cooling holes 120 on the outer shell.

Although an embodiment of this invention has been disclosed, a worker of ordinary skill in this art would recognize that certain modifications would come within the scope of this disclosure. For that reason, the following claims should be studied to determine the true scope and content of this disclosure.

1. A combustor for use in a gas turbine engine comprising:
a panel with first cooling holes extending through said panel, said first cooling holes communicating with an inner face of said panel to deliver cooling air to said inner face of said panel, and an outer shell attached to said panel, said outer shell having second cooling holes extending to deliver air to a chamber between said outer shell and said panel, and then into said first cooling holes; and
there being a nominal average spacing of at least one of said second cooling holes and said first cooling holes per an entire surface area of said outer shell or said panel respectively, and a reduced spacing area of said at least one of said second cooling holes and said first cooling holes adjacent to at least one edge on said panel, and said at least one of said second cooling holes and said first cooling holes in said reduced spacing area being spaced by a distance less than said nominal average spacing.

2. The combustor as set forth in claim 1, wherein said edge being an outer surface of a boss around a circumference of one of the dilution or an ignitor hole.

3. The combustor as set forth in claim 1, wherein a rail is provided about an outer face of said panel, and the edge is measured from a wall of the rail facing into the panel.

4. The combustor as set forth in claim 3, wherein said edge being a leading edge of said panel.

5. The combustor as set forth in claim 3, wherein said edge being a trailing edge of said panel.

6. The combustor as set forth in claim 3, wherein said edge being circumferential edges of said panel.

7. The combustor as set forth in claim 6, wherein at least at said circumferential edges, said first cooling holes extending from said outer face of said panel to an outlet at said inner face at a location aligned with said rail at said circumferential edges.

8. The combustor as set forth in claim 7, wherein said first cooling holes extend in opposed angular directions that are non-perpendicular and non-parallel to said outer face, such that said outlets are spaced closer to each of said circumferential edges than are inlets to said first cooling holes.

9. The combustor as set forth in claim 1, wherein said at least one of said second cooling holes and said first cooling holes is said second cooling holes.

10. The combustor as set forth in claim 9, wherein said at least one of said second cooling holes and said first cooling holes is both said second cooling holes and said first cooling holes.

11. The combustor as set forth in claim 1, wherein said reduced spacing area also having a greater density of cooling hole area than a nominal average density of cooling hole area.

12. The combustor as set forth in claim 1, wherein a spacing between adjacent ones of said at least one of said second cooling holes and said first cooling holes in said reduced spacing area being equal to or less than ten (10) average diameter of said first cooling holes.

13. The combustor as set forth in claim 1, wherein the term adjacent is defined by being spaced by a distance from said at least one edge equal to or less than ten (10) average diameter of said at least one of said second cooling holes and said first cooling holes.

14. The combustor as set forth in claim 1, wherein said first cooling holes are effusion cooling holes and said second cooling holes are impingement cooling holes.

15. The combustor as set forth in claim 14, wherein said reduced spacing area being between said effusion cooling holes, and at both circumferential edges, one of a leading and a trailing edge of said panel, and at a circumference of a dilution or ignitor hole.

16. A combustor section for a gas turbine engine comprising:
a panel with effusion cooling holes extending through said panel, said effusion cooling holes communicating with an inner face of said panel to deliver cooling air to said inner face of said panel, and an outer shell attached to said panel, said outer shell having impingement cooling holes extending to deliver air to a chamber between said outer shell and said panel, and then into said effusion cooling holes; and
there being a nominal average density of effusion cooling hole area per surface area of said panel, and an increased density area of cooling holes adjacent to at least one edge on said panel, said increased density area having a density greater of cooling hole area than said nominal average density.

17. The combustor section as set forth in claim 16, wherein said impingement cooling hole also having an increased density area adjacent to said at least one edge.

18. The combustor section as set forth in claim 16, wherein an outer face of said panel having a rail, at least at said circumferential edges, and said effusion cooling holes extending from said outer face of said panel to an outlet at said inner face at a location aligned with said rail at said circumferential edges.

19. The combustor section as set forth in claim 16, wherein the term adjacent is defined by being spaced by a distance from said at least one edge equal to or less than ten (10) average diameter of said effusion holes.

20. The combustor section as set forth in claim 16, wherein said increased density area being found at both circumferential edges, one of a leading and a trailing edge of said panel, and at a circumference of a dilution or ignitor hole.

21. A combustor for use in a gas turbine engine comprising:
a panel having a pair of circumferential edges, a leading edge and a trailing edge, with first cooling holes extending through said panel, said first cooling holes communicating with an inner space of said panel to deliver cooling air to said inner face of said panel, and an outer shell attached to said panel, said panel having an outer face with a rail extending to contact said outer shell, with said rail being formed at least at said circumferential edges of said panel, said outer shell having second cooling holes extending to deliver air to a chamber between said outer shell and said panel, and then into said first holes; and
said first cooling holes including an inlet on said outer face, and extending to outlets at said inner face, with said outlets of some of said first cooling holes being spaced closer to said circumferential edges of said panel than said inlets such that outlets of some of said first cooling holes will be aligned with said rails at each of said circumferential edges.
